(19) United States
(12) Patent Application Publication
(10) Pub. No.: US 2003/0225814 A1
(43) Pub. Date: Dec. 4, 2003

(54) Signal distribution device for load sharing multiprocessor

(76) Inventors: Makoto Saito, Yokohama (JP); Yoshimi Sasaki, Yokohama (JP); Kazuaki Oishi, Yokohama (JP)

Correspondence Address: KATTEN MUCHIN ZAVIS ROSENMAN, 575 MADISON AVENUE, NEW YORK, NY, 10022-2585, US

(21) Appl. No.: 10/308,432

(22) Filed: Dec. 3, 2002

(30) Foreign Application Priority Data
May 31, 2002 (JP) 2002-160481

(51) Int. Cl. G06F 9/00

(52) U.S. Cl. 709/105

(57) ABSTRACT

The signal distribution apparatus includes a plurality of processors and a distribution portion. The distribution portion is prepared per distribution unit and is set in at least one of the plurality of processors. Each distribution portion receives receiving control signals and distributing the control signal to one of the plurality of processors.

### BACKGROUND OF THE INVENTION

1. Field of the Invention

The present invention relates to a signal distribution apparatus for a load sharing (balancing) multiprocessor and, more particularly, to a technique which distributes signals so that loads on a plurality of processors are equalized to each other.

2. Description of the Related Art

In a prior art, for various communication systems applied to, e.g., a circuit switching system and a mobile communication system, a processing balancing scheme for received signals by a multiprocessor is employed. As one of processing sharing (balancing) methods, a load sharing (balancing) scheme is known. The load sharing scheme is generally realized by using an apparatus configuration (load sharing system) as shown in FIG. 14. In FIG. 14, a load sharing apparatus receives control signals (messages) from external systems. The control signal is, e.g., a signal for performing a call connection process or a maintenance operation. The load distribution apparatus selects a processor so that the loads on a plurality of processors A to D are equalized to each other, and transmits a control signal to the selected processor when receives a control signal. The processors A to D respectively perform processing (transaction) to the control signal while referring to and/or updating call states stored in a shared memory.

The processors A to D respectively start by receiving a control signal from the load sharing apparatus. Periods of time from when each processor receives the control signal to when each processor finishes processing about the received control signal are different from each other, depending on individual differences of each processor and weights of processing (periods of time required for the processing) For this reason, as shown in FIG. 15, the reception order of the control signals by the processors and the order of end of processing on each processor may be inverted.

The apparatus configuration (load sharing system) shown in FIG. 14 is applied to a base station controlling apparatus for a mobile communication system as shown in FIG. 16. In FIG. 16, in the base station controlling apparatus, a control signal from an external device (illustrated as a base station, an exchange, and a monitoring device in FIG. 16) is transmitted to any one of signaling units (SU) through a signal terminating unit and a line connecting circuit. Each signaling unit transmits the received control signal to a load sharing system. The load sharing system includes a signal processor. The signal processor has the same function as that of the load sharing apparatus illustrated in FIG. 14. The signal processor, when receives a control signal, selects a processor so that the loads on the processors A to D are equalize to each other, and transmits the control signal to the selected processor. Each processor performs processing for the received control signal while referring to and/or updating a call state or the like stored in the shared memory. In this manner, the processors A to D perform parallel processing to a plurality of control signals. At this time, the inversion (see FIG. 15) of the orders as described above occurs. In contrast to this inversion, a method for preventing the order from being inverted is performed by the following signal processor scheme.

More specifically, in the signal processor scheme, a multiprocessor (processors A to D in FIG. 16) is constituted such that the processes for the control signals are performed in units of calls. More specifically, the processors are correlated with call numbers. The signal processor refers to a call number specified on the basis of information elements included in the control signal and transmits to a corresponding processor. In this manner, the order of the control signals transmitted and received by the same call are prevented from being inverted.

When the signal processor distributes control signals to the processors, the signal processor extracts a information element (key information) taken along divided units of the processors from each of the control signals, and transfer the control signals to corresponding processors on the basis of the key information. For example, when the multiprocessor (processors A, B, C and D) is divided in units of calls, the signal processor specifies a call number corresponding to a control signal and transfers the control signal to the processor specified on the basis of the call number.

However, the assumption of the above-mentioned signal processor scheme is that specific key information, such as “call numbers” is set in predetermined positions of all the control signals. Therefore, when information elements to be used as key information for each control signal are different from each other or when formats of the control signals are changed, processes relating to extracting the key information must be changed. In this case, since the signal processors (hardware) must be changed, the flexibility of the system is deteriorated.

In the prior art, all the control signals are collected at a single signal processor. When a quantity of control signal (e.g., a traffic density) is large, a distribution process in the signal processor may be bottlenecks. In order to relieve the bottlenecks, a plurality of signal processors may be prepared, or the performances of the signal processors may be increased. However, these measures are not preferable because the costs of products increase.

In addition, in the prior art, all the control signals are collected at a single signal processor, and the signal processor distributes the control signals to the processors. For this reason, there is possibility that all the control signals in the signal processor are lost when a trouble occurs in the signal processor. For this reason, a spare signal processor may be prepared. However, until the signal processor in which the trouble occurs is switched to the spare processor, a part of or all the control signals in the signal processor may be lost.

### SUMMARY OF THE INVENTION

It is an object of the present invention to provide a signal distribution apparatus for a load sharing multiprocessor which can flexibly cope with a change of a system.

It is another object of the present invention to provide a signal distribution apparatus for a load sharing multiprocessor which can relieve the bottleneck of a signal distribution process.

It is still another object of the present invention to provide a signal distribution apparatus for a load sharing multiprocessor which can widen a support range of control signals.

The present invention provides a signal distribution apparatus for a load sharing multiprocessor including:

a plurality of processors; and

at least one distribution portion which is prepared per distribution unit and is set in at least one of the plurality of processors, wherein each distribution portion receives control signals and distributes each control signal to one of the plurality of processors.

The present invention is preferably designed such that at least one signal processing portion processing a control signal is set at least one of the plurality of processors, and the distribution portion distributes a control signal to any one of the plurality of processors in which the signal processing portion is set.

The distribution portion according to the present invention is preferably designed such that the distribution portion specifies a processor corresponding to a distribution destination on the basis of a piece of key information specified from an information element being included in a control signal.

The distribution unit according to the present invention is preferably designed such that the distribution portion distributes a plurality of control signals in which load balancing units specified by the key information are equal to each other to the same processor in the order of reception of the plurality of control signals.

The present invention is preferably designed to further include changing means for dynamically changing setting state of at least one distribution portion for the plurality of processors.

### BRIEF DESCRIPTION OF THE DRAWINGS

FIG. 1 is a diagram showing an outline of the present invention;

FIG. 2 is a sequence diagram showing processings according to the present invention;

FIG. 3 is a diagram of a base station control apparatus according to the first embodiment of the present invention;

FIG. 4 is a sequence diagram showing processings (operations) performed when the base station control apparatus receives a control signal;

FIG. 5 is a sequence diagram showing processings (operations) according to a change in mapping of a distribution CP;

FIG. 6A is a diagram showing a shared memory distribution CP table, and FIG. 6B is a diagram showing a distribution CP table prepared for each signaling unit;

FIG. 7 is a diagram showing a processor table;

FIG. 8 is a flow chart showing an outline of the processing of the entire apparatus when the base station control apparatus receives a control signal;

FIG. 9 is a flow chart showing a process in each main device when the base station control apparatus receives a control signal;

FIG. 10 is a flow chart showing processes related to a change of distribution CPs;

FIG. 11 is a diagram of a base station control apparatus according to the second embodiment of the present invention;

FIG. 12A is a diagram showing a shared memory distribution CP table in the second embodiment, and FIG. 12B is a diagram showing a distribution CP table in the second embodiment;

FIG. 13 is a diagram showing a processor table in the second embodiment;

FIG. 14 is a diagram for explaining a prior art;

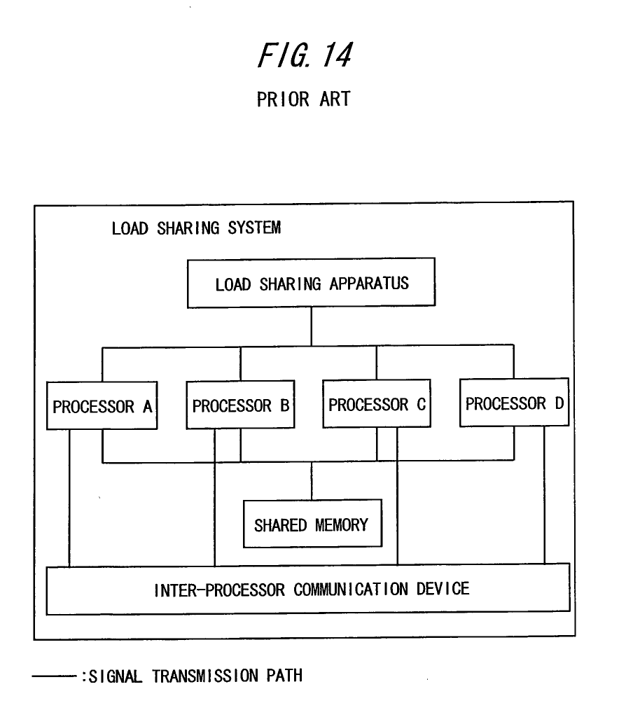

FIG. 15 is a diagram for explaining the prior art; and

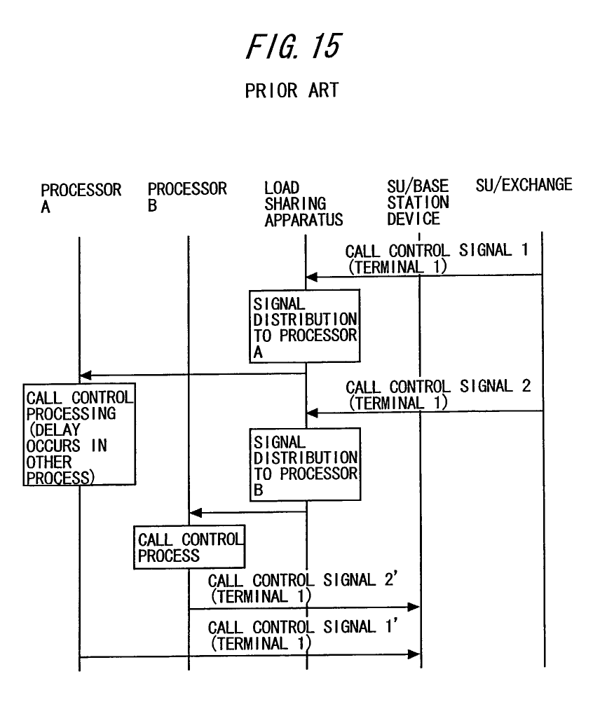

FIG. 16 is a diagram for explaining the prior art.

### DESCRIPTION OF THE PREFERRED EMBODIMENTS

[Description of the Invention]

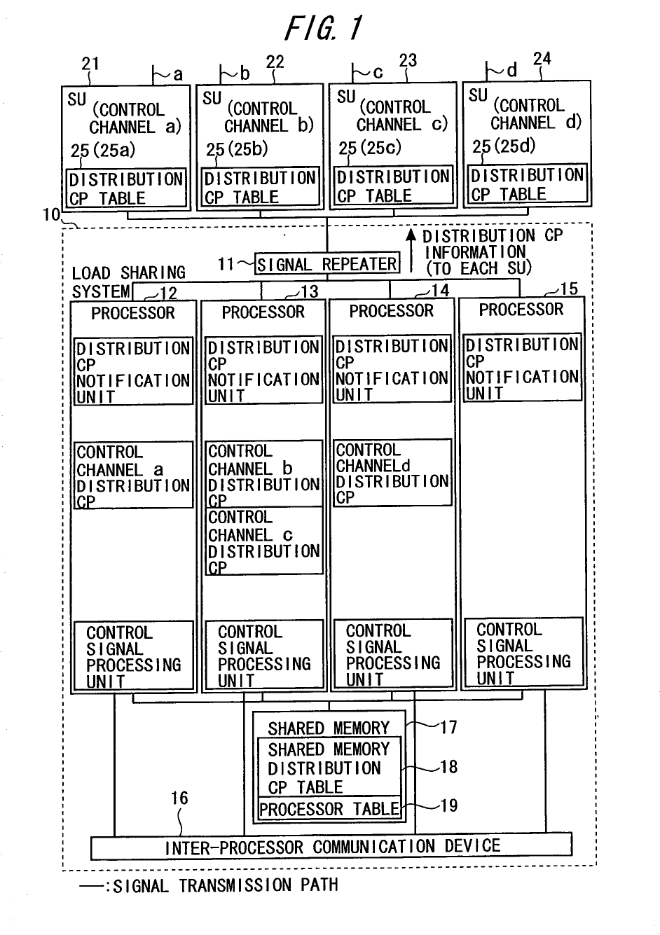

An outline of the present invention will be described first. FIG. 1 is a diagram showing an outline of the present invention. FIG. 1 shows a load sharing system 10 having a signal distribution apparatus according to the present invention. The load sharing system 10 is connected to, e.g., a plurality of signaling units (SUs). FIG. 1 illustrates a plurality of signaling units 21 to 24.

The signaling unit 21 handles control signals (messages) related to a control channel (a), the signaling unit 22 handles control signals related to a control channel (b), the signaling unit 23 handles control signals related to a control channel (c), and the signaling unit 24 handles control signals related to a control channel (d).

The load sharing system 10 includes a signal repeater (signal relay device) 11 for relaying control signals from the signaling units, a plurality of processors (for example, illustrated as processors 12 to 15 in FIG. 1) connected to the signal repeater 11, an inter-processor communication device 16 for controlling communication between the processors, and a shared memory 17 which is referred to or updated by the processors.

The present invention is applied to a multiprocessor constituted by a plurality of hardware processors prepared in predetermined units such as calls, terminals, or base stations. In the example in FIG. 1, the hardware processors 12 to 15 constitute the multiprocessor.

In the present invention, at least one “distribution processing unit (distribution CP)” serving as distribution portion for performing a distribution process of control signals when the control signals are received and at least one “control signal processing unit (processing units)” serving as signal processing portion for actually processing the control signals are set (mapped) on at least one of the processors. The distribution CP is a logical processor set on a hardware processor, and the control signal processing unit is a logical processor set on a hardware processor.

The distribution CP is prepared for each (per) predetermined distribution unit. The distribution unit is, e.g., a control channel. The distribution CP is prepared for each (per) control channel. In the example in FIG. 1, distribution CPs the number of which depends on the control channels (a) to (d) are prepared. The mapping state of the distribution CPs is held and managed by a shared memory distribution CP table 18 formed on the shared memory 17 and a distribution CP table 25 arranged (set) in each of the signaling units. FIG. 1 illustrates distribution CP tables 25a, 25b, 25c, and 25d.

In a processor on which the distribution CP is mapped (allocated or set), a distribution CP notification unit is arranged (set). The distribution CP notification unit functions as a notification portion for detecting a trouble, a congestion, or a maintaining operation in the processor to notify a signaling unit of distribution CP information (number (identification information) of a distribution CP). The distribution CP notification unit operates only when the distribution CPs are mapped (set). The mapping states of the distribution CPs are changed by using detection of a trouble or the like caused by the distribution CP notification unit as a trigger. Initial mapping of the distribution CPs are statically performed by, e.g., initial setting.

The mapping state of the control signal processing units is held and managed by a processor table 19 formed on the shared memory 17. The mapping of the control signal processing units can be statically performed by, e.g., initial setting. The control signal processing units can also be dynamically allocated by using a predetermined condition (e.g., generation of a call) as a trigger.

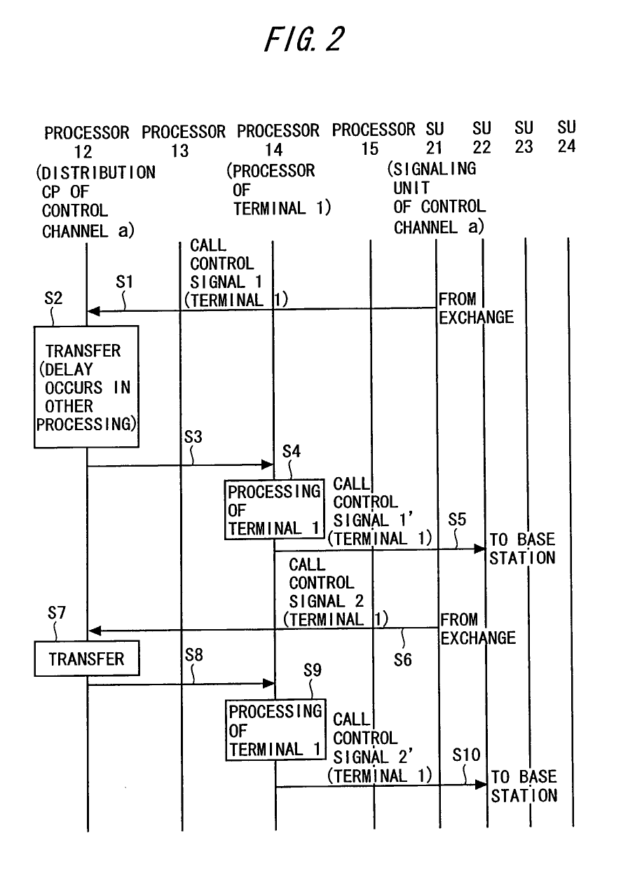

FIG. 2 is a sequence diagram showing an operation of the load sharing system 10 shown in FIG. 1. When the signaling unit 21 receives a control signal (call control signal 1 (terminal)) related to the control channel (a) from an exchange (not shown), the call control signal 1 is transferred, through the signal repeater 11, to a processor on which the distribution CP corresponding to the control channel (a) is mapped (step S1).

More specifically, the signaling unit 21 refers to the distribution CP table 25 (25a), specifies a transfer destination of a control signal, and transfers the control signal to the distribution CP corresponding to the transfer destination. In this case, the call control signal 1 of the control channel (a) is transferred to the distribution CP mapped on the processor 12 (step S1).

When the distribution CP of the control channel (a) receives the call control signal 1, the distribution CP refers to the processor table 19 of the shared memory 17 to specify a processor in which a control signal processing unit for processing the call control signal 1 is mapped. More specifically, the distribution CP extracts at least one information element serving as key information for specifying a distribution destination from the call control signal 1 and read a distribution destination corresponding to the key information from the processor table 19 to specify the distribution destination.

In this example, the processors 12 to 15 are prepared in units of terminals (per terminal), and a control signal processing unit which is to process a call control signal related to the terminal 1 (not shown) is mapped on the processor 14 in advance. Therefore, the distribution CP of the control channel (a) transfers the call control signal 1 to the control signal processing unit of the processor 14 through the inter-processor communication device 16 (step S2). The call control signal 1 reaches the control signal processing unit of the processor 14 (step S3).

When the control signal processing unit (control signal processing unit of the terminal 1) of the processor 14 receives the call control signal 1, the control signal processing unit terminates the call control signal 1 to perform a predetermined processing (processing relating to the terminal 1) (step S4) and generates and outputs a call control signal 1′. The call control signal 1′ is transferred to a base station (not shown) through the signal repeater 11 and a predetermined signaling unit (in this case, the signaling unit 23) (step S5).

Thereafter, when the signaling unit 21 receives a call control signal 2 (terminal 1), the call control signal 2 is processed through the same route as in steps S1 to S5 (steps S6 to S9). A call control signal 2′ generated on the basis of the processing result is transferred to the base station (step S10).

In this manner, according to the present invention, the control signal of the control channel (a) is necessarily transferred to the distribution CP of the processor 12, and the control signal of the terminal 1 is distributed to the control signal processing unit of the processor 14 by the distribution CP of the processor 12. Therefore, the control signal related to the terminal 1 of the control channel (a) is necessarily processed through the same route. In this manner, even though a processing performed by the distribution CP is delayed, when the distribution CP performs a distribution process to the control signals in the order of reception, the order of control signals in the same control channel can be prevented from being inverted.

In addition, in a prior art, a distribution destination is referred to with reference to an information element of a control signal at a signal processor (hardware). In contrast to this, in the present invention, a processor in which a distribution CP is mapped (set) specifies key information with reference to the information element included in a control signal and performs a distribution process. More specifically, according to the present invention, the distribution CP serving as a logical processor realized by executing software by a processor (hardware) performs a distribution process of a control signal.

For this reason, when only the software installed in the process is changed, the processor can cope with a change in format of a control signal. In contrast to this, in the prior art, signal processors (hardware) must be exchanged. With respect to this point, according to the present invention, the system can be flexibly changed.

In addition, according to the present invention, when a reference position (reference portion) of an information element depending on the type of a control signal (message) is designated in advance, with respect to the software realizing the distribution CP the distribution CP can extract an information element depending on the type of a control signal to specify key information. According to the present invention, with respect to this point, the system can be flexibly changed.

In the present invention, distribution CPs may be separately arranged in predetermined distribution units (e.g., in units of control channels) for a plurality of processors. For this reason, the bottleneck of a signal processor in the prior art, i.e., the bottleneck of a distribution process can be prevented from being generated.

With respect to this point, according to the present invention, a mapping state (setting state) of the distribution CPs can be changed depending a quantity of control signal (e.g., a traffic density). For example, when the quantities of control signals are small, all the distribution CPs are mapped on an arbitrary processor. When the quantity of control signal increases (the distribution CP notification unit detects congestion), control can be performed such that the distribution CPs are mapped on another processor (destination (position) on which the distribution CPs are mapped). In this manner, a processor on which no distribution CP is mapped can smoothly execute a processing for a control signal.

When a processor on which the distribution CPs are mapped is the same as a processor to which a control signal is distributed, the control signal need not be transferred through the inter-processor communication device 16. As described above, according to the present invention, the performance of a processing for a control signal can be improved.

Furthermore, in the prior art, when a trouble occurs in the signal processor a part of or all the control signals may be lost. In contrast to this, according to the present invention, when a trouble occurs in a certain processor, only a control signal transferred to the distribution CP mapped on the processor may be partially lost. Control signals transferred to the distribution CPs mapped on the other processors are not adversely affected. In this manner, according to the present invention, a signal support range is wider than that of the prior art.

In the prior art, when a trouble occurs in the signal processor, the signal processor may be switched to a spare signal processor. However, in this case, when the spare signal processor is not operated in a hot-standby state, operation reliability is poor. In contrast to this, according to the present invention, since the distribution CPs are re-mapped on an active processor, high operation reliability can be achieved.

[First Embodiment]

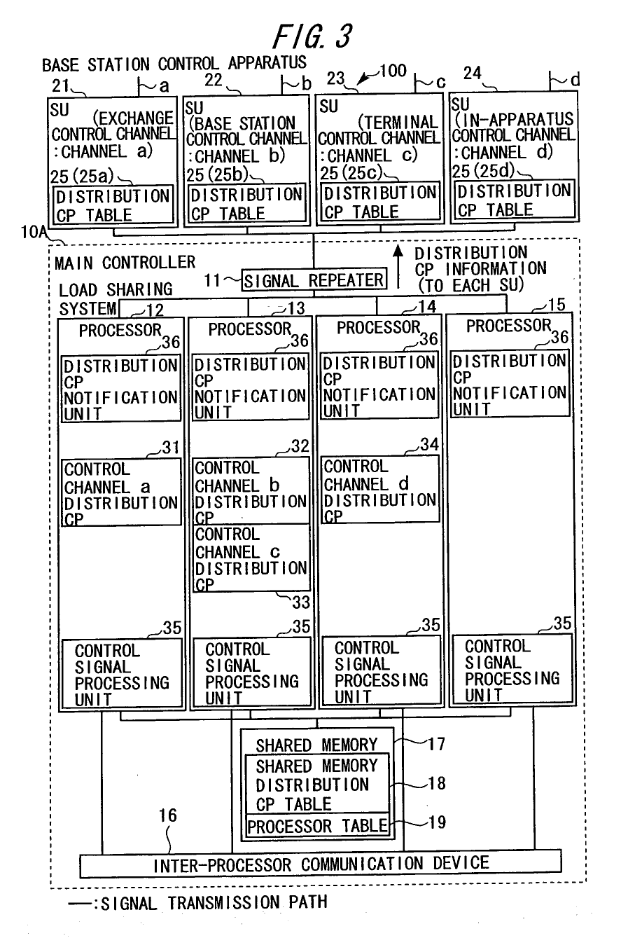

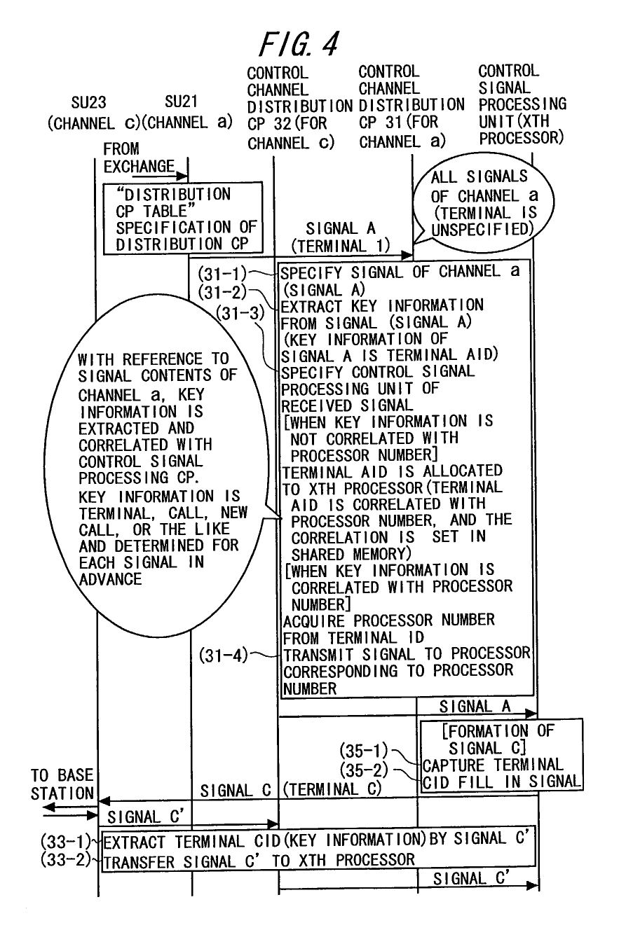

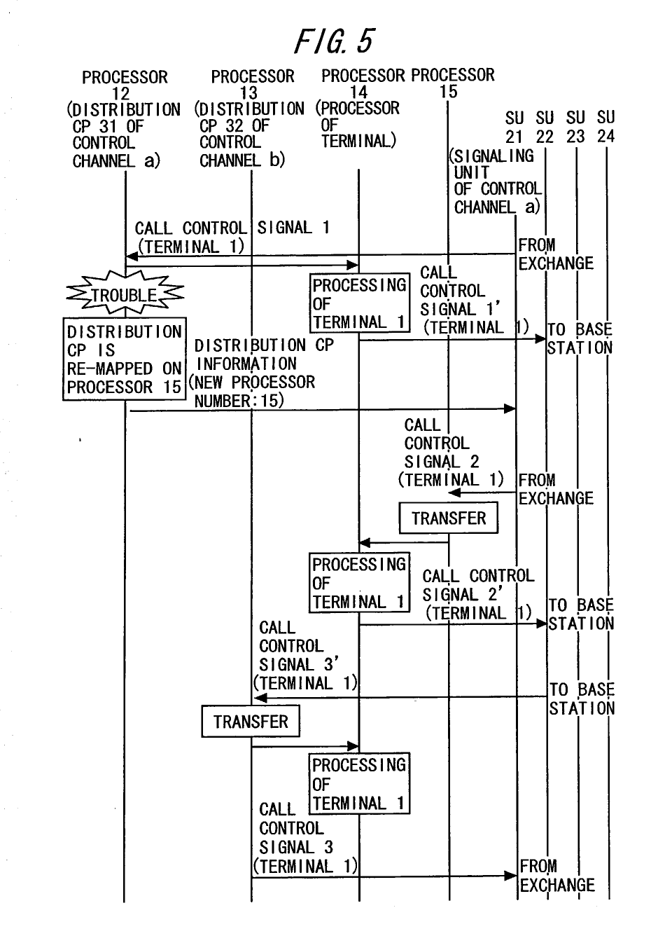

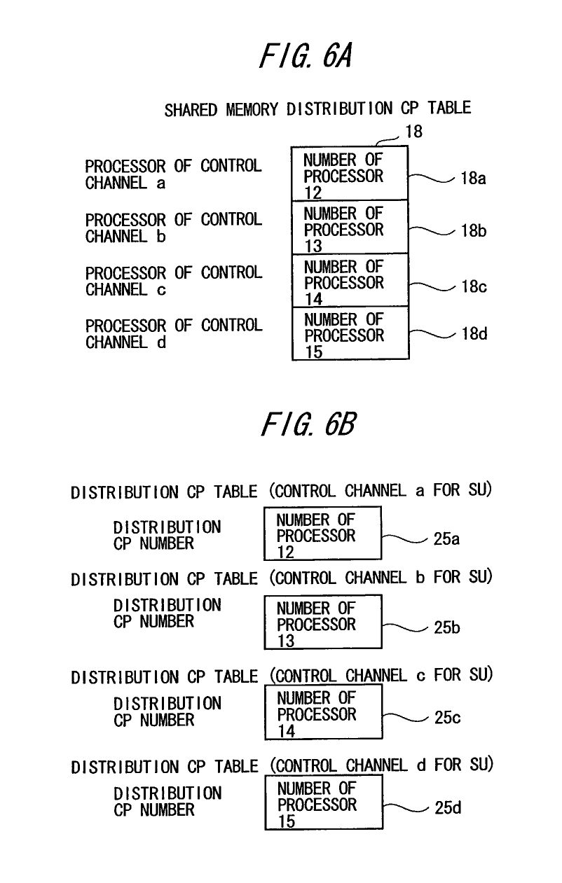

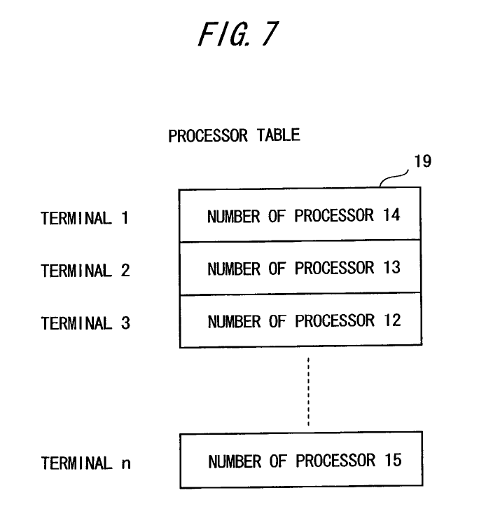

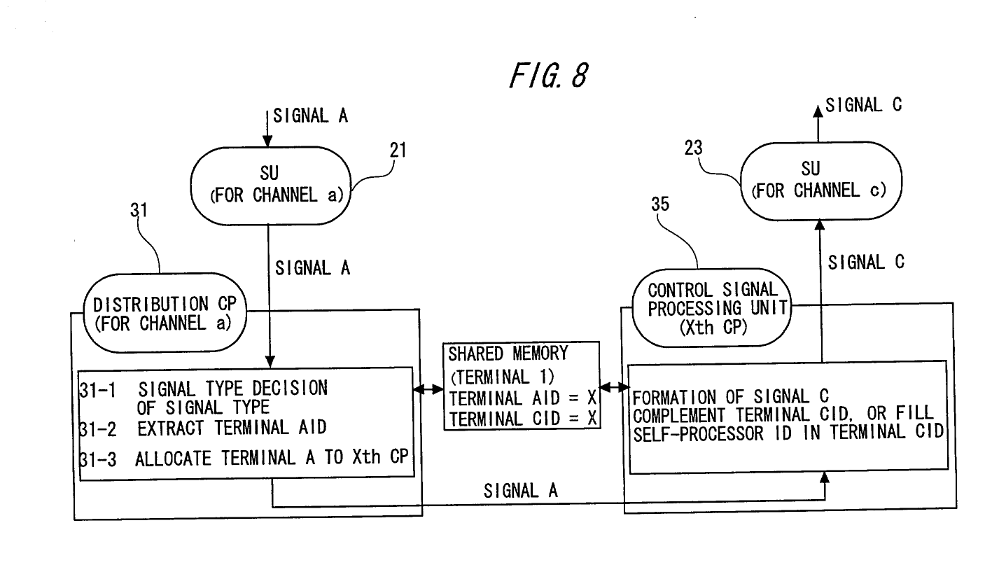

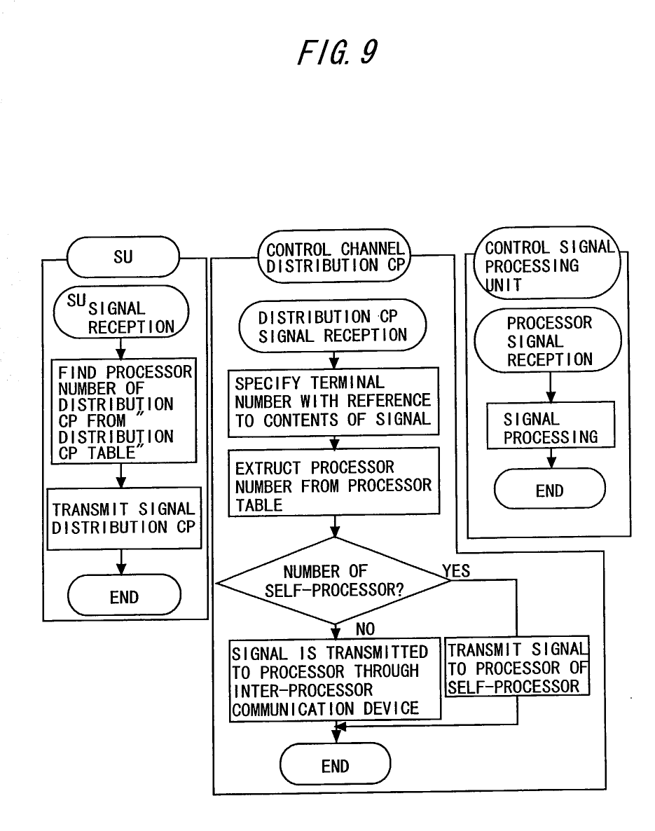

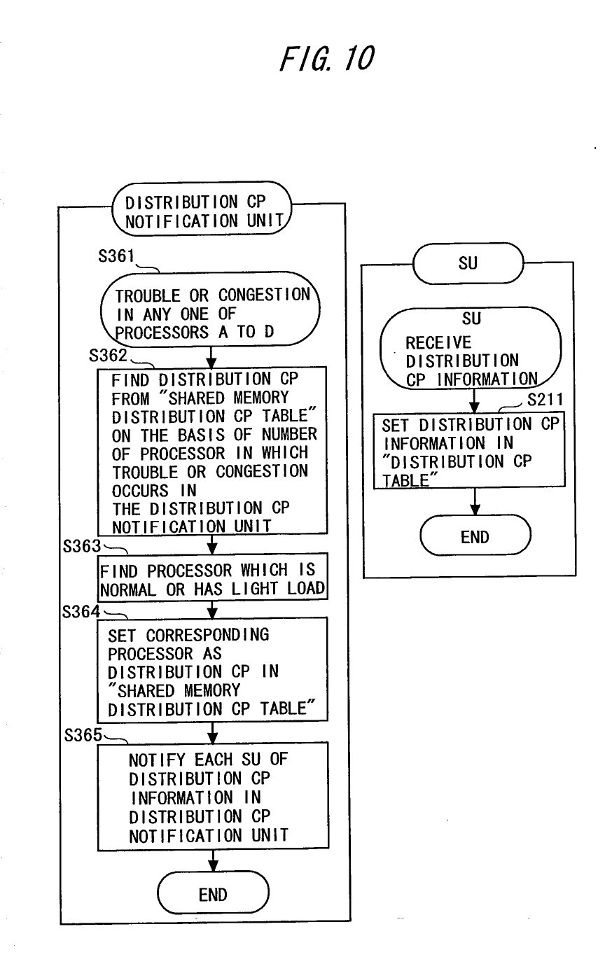

The first embodiment of the present invention will be described below. FIG. 3 is a diagram of a base station control apparatus 100 according to the first embodiment of the present invention. FIG. 4 is a sequence diagram showing processes (operations) performed when the base station control apparatus 100 receives a control signal. FIG. 5 is a sequence diagram showing processes (operations) related to a change in mapping of distribution CPs. FIG. 6A is a diagram showing a shared memory distribution CP table, and FIG. 6B is a diagram showing a distribution CP table prepared for each signaling unit. FIG. 7 is a diagram showing a processor table. FIG. 8 is a flow chart showing an outline of processes in the entire apparatus when the base station control apparatus receives a control signal. FIG. 9 is a flow chart showing processes performed in main units when the base station control apparatus receives a control signal. FIG. 10 is a flow chart showing processes related to a change of distribution CP.

The base station control apparatus is connected between an exchange and a plurality of base stations, and has a call connection function as a main function. The base station control apparatus terminates and manages a control channel between the base station control apparatus and the exchange, a control channel between the base station control apparatus and the base station, a control channel of a subscriber's terminal (terminal), and also manages an in-apparatus control channel for managing function blocks in the apparatus.

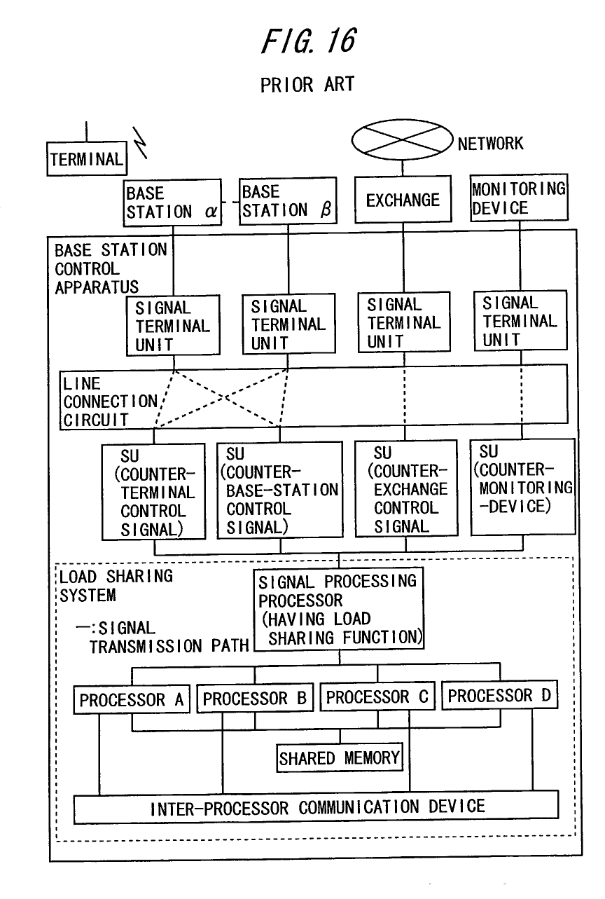

In the base station control apparatus 100 shown in FIG. 3, a plurality of signaling units 21 to 24 and a main controller 10A are shown as main constituent elements related to realization of the present invention. The base station control apparatus 100, as shown in FIG. 16, includes a line connection circuit connected to the signaling units 21 to 24 and a plurality of signal terminal units connected to the line connection circuit. The base stations and the exchange are connected to the signal terminal units. A monitoring device may be connected. Since the configuration is the same as that of a prior art, a description thereof will be omitted.

The signaling units 21 to 24 have the same configurations as those of the signaling units 21 to 24 shown in FIG. 1. In FIG. 3, the signaling unit 21 receives a control signal from the control channel (a) of an exchange. The signaling unit 22 receives a control signal from the control channel (b) from the base station. The signaling unit 23 receives a control signal from the control channel (c) from the terminal. The signaling unit 24 receives a control signal from the in-apparatus control channel (d). Each of signaling units 21 to 24 receives the control signals. Each signaling unit, per control signal, terminates the low-layer parts of the control signal and transfers the control signals to the main controller 10A to terminate the high-layer parts of the control signal. Then, each of signaling units 21 to 24 refers to the distribution CP tables 25 to transfer the control signals to a processor corresponding to a transfer (distribution) destination.

The main controller 10A corresponds to the load sharing (balancing) system 10 shown in FIG. 1, and employs a load sharing scheme for each terminal. The main controller 10A, like the load sharing system 10, has a signal repeater 11, a plurality of processors 12 to 15, an inter-processor communication device 16, and a shared memory 17. The shared memory 17 stores a shared memory distribution CP table 18 and a processor table 19.

In the first embodiment, the distribution CPs are mapped as described below. As shown in FIG. 6A, the shared memory distribution CP table 18 (hereinafter referred to as “table 18”) stores processor numbers for the processor corresponding to the respective control channels. A processor having a processor number corresponding to a control channel corresponds to a mapping destination of a distribution CP.

In the example shown in FIG. 6A, the processor 12 is allocated to the control channel (a), the processor 13 is allocated to the control channels (b) and (c), and the processor 14 is allocated to the control channel (d). In the example shown in FIG. 6A, four records 18a to 18d depending on the number of control channels are prepared, the records are prepared (set) depending on the number of control channels (distribution units).

On the other hand, the distribution CP tables 25 arranged in the signaling units 21 to 24, respectively, store the numbers of the processors corresponding to control channels stored in the signaling units. For example, as shown in FIG. 6, the distribution CP table 25a of the signaling unit 21 stores the number of the processor 12 as a processor number corresponding to the control channel (a). More specifically, the storage contents of the distribution CP table 25a are the same as those of the record 18a of the table 18. The distribution CP table 25b of the signaling unit 22 stores the number of the processor 13 as a processor number corresponding to the control channel (b). More specifically, the storage contents of the distribution CP table 25b are the same as those of the record 18b of the table 18. The distribution CP table 25c of the signaling unit 23 stores the number of the processor 13 as a processor number corresponding to the control channel (c). More specifically, the storage contents of the distribution CP table 25c are the same as those of the record 18c of the table 18. The distribution CP table 25d of signaling unit 24 are stores the number of the processor 14 as a processor number corresponding to the control channel (d). More specifically, the storage contents of the distribution CP table 25d are the same as those of the record 18d of the table 18.

The distribution CPs are mapped according to the storage contents of the shared memory distribution CP table 18. In FIG. 3, according to the contents shown in FIG. 6A, a distribution CP 31 of the control channel (a) is arranged in the processor 12, distribution CPs 32 and 33 of the control channels (a) and (b) are arranged in the processor 13, and a distribution CP 34 of the control channel (d) is arranged in the processors 15. In this manner, the distribution CP may be arranged in at least one of the processors, and the distribution CPs need not be arranged in all the processors. The functions of the distribution CPs 31 to 34 are the same as those described in the outline of the present invention.

On the other hand, the control signal processing units are mapped as follows. More specifically, as shown in FIG. 7, in the processor table 19, for respective pieces of identification information of predetermined load sharing units (e.g., calls, terminals, base stations, and the like) for the multiprocessor, the processor numbers of the processors which processes the control signals corresponding to the load sharing units are stored. In the first embodiment, the load sharing units are terminals, and the corresponding processor numbers (processor numbers corresponding to allocation destination (distribution destination by the distribution CPs) are stored for the terminals (terminals 1 to n: n is an integer which is 1 or more), respectively.

For example, as shown in FIG. 7, the number of the processor 14 is stored as an allocation destination of the terminal 1, the number of the processor 13 is stored as an allocation destination of the terminal 2, the number of the processor 12 is stored as an allocation destination of the terminal 3, and the number of the processor 15 is stored as an allocation destination of the terminal n. As a matter of course, each of a plurality of terminals is allocated to one processor.

The control signal processing units are mapped in the processors 12 to 14 according to the storage contents of the processor table 19. In the example shown in FIG. 3, control signal processing units 35 are arranged in the processors 12 to 15 according to the storage contents of the processor table 19 shown in FIG. 7. The control signal processing units 35 have the functions described in the outline of the present invention.

The control signal processing units 35 may not be arranged in all the processors. In contrast to this, the control signal processing units 35 may be arranged in all the processors, and the storage contents of the processor 15 may simply indicate an allocation destination of a processing of a control signal.

In FIG. 3, the distribution CP notification units 36 are arranged in all the processors 12 to 15, respectively. The distribution CP notification units 36 have functions described in the outline of the present invention. The distribution CP notification unit 36 need not be arranged in a processor on which the distribution CP is not expected to be mapped (arranged).

The inter-processor communication device 16 has the function described in the outline of the present invention. The inter-processor communication device 16 controls communication processes (e.g., transfer processes of control signals) between the processors 12 to 15.

Processes (operations) of the base station control apparatus 100 when the control signal is received will be described below with reference to FIGS. 4, 8, and 9. For example, when the signaling unit 21 receives a control signal (signal A) from the control channel (a), the signaling unit 21 refers to the distribution CP table 25a, specifies the processor 12 as a transfer destination of the signal A, and transfers the signal to the processor 12. In this manner, the distribution CP 31 corresponding to the transfer destination of the signal A is specified, and the signal A is transferred to the distribution CP 31.

When the distribution CP 31 receives the control signal of the control channel (a), the distribution CP 31 specifies the type of the signal from the control channel (a) first (FIGS. 4 and 8: 31-1). In this manner, the distribution CP 31 recognizes that the received signal is the signal A.

The distribution CP 31 extracts key information for specifying a load sharing unit (terminal) from the control signal (FIGS. 4 and 8: 31-2). It is assumed that the key information of the signal A is a terminal AID (terminal ID: A) included in the signal A as an information element. In this case, the distribution CP 31 extracts the terminal AID as key information from the control signal. The terminal AID is a terminal ID which indicates the terminal 1 (formed depending on the type and the format type of the terminal A) corresponding to the signal A. The key information is specified on the basis of the information element such as a terminal ID, a call ID (call number), or the like included in the control signal. The key information may be specified on the basis of one information element, or may be specified on the basis of a plurality of information elements. A specific information element extracted to specify key information is set in the distribution CP depending on the type of the control signal in advance. When the distribution CP specifies the type of the control signal, a position where the information element for specifying key information is stored can be specified or discriminated.

The distribution CP 31 specifies a control signal processing unit (processor having a control signal processing unit) which is to process a control signal (FIGS. 4 and 8: 31-3). More specifically, the distribution CP 31 refers the processor table 19 of the shared memory 17. At this time, when no processor number corresponding to the terminal 1 (terminal AID) is stored, in consideration of a load on the processor, an arbitrary processor is newly allocated to the terminal 1. As a method of allocating the processor, a conventional method can be used. For example, a processor (Xth processor) having the lightest load at this point is specified, the number of the processor and the terminal AID of the terminal 1 are correlated with each other and stored in the processor table 19. In this manner, the loads on the plurality of processors are shared. The allocation process of the new processor is performed when the signal A is a control signal for setting a new call (when call is generated). On the other hand, when the processor number corresponding to the terminal 1 (terminal AID) is stored in the processor table 19, the distribution CP 31 acquires the processor number.

The distribution CP 31 transfers the control signal (signal A) to a processor having the processor number (newly allocated processor number) newly stored in the processor table 19 or the processor number acquired from the processor table 19 (FIG. 4: 31-4). For example, the distribution CP 31 transfers the control signal (signal A) to the processor 14 through the inter-processor communication device 16 according to the storage contents of the processor table 19 shown in FIG. 7. However, when the processor number corresponding to the transfer destination is the number of the self-processor, the distribution CP 31 transmits the control signal to the control signal processing unit 35 of the self-processor (see FIG. 9).

When the Xth processor (processor 14) receives the control signal (signal A), the control signal processing unit 35 terminates the control signal (signal A). The terminating process is, e.g., the process which transmits a call processing signal to the base station or the exchange as a call processing of the terminal. In the example shown in FIGS. 4 and 8, as a terminating process to the control signal (signal A), a signal C (call processing signal) related to the terminal 3 is generated.

At this time, the control signal processing units 35 captures a terminal ID (terminal CID; terminal ID: C) of the terminal 1 depending on the type and the format type of the signal C from the shared memory 17 (processor table 19) (FIGS. 4 and 8: 35-1), generates the signal C in which the terminal CID is filled (FIGS. 4 and 8: 35-2), and transmits the signal C. In this case, the signal C (call processing signal) is transferred from the processor (in this example, the processor 14) to a signaling unit corresponding to the destination of the signal C without passing through the distribution CP. When the terminal CID is captured from the shared memory 17, the terminal CID (terminal 1) and the number of the processor 14 (Xth processor) are correlated with each other and stored in the processor table 19.

Thereafter, as shown in FIG. 4, it is assumed that the signaling unit 23 receives a signal C′ corresponding to a response signal of the signal C from the control channel (c). The signal C′ includes the terminal CID filled in the signal C. The signaling unit 23 transfers the signal C′ to the distribution CP 33 of the processor 13 corresponding to the transfer destination according to the storage contents of the distribution CP table 25c.

The distribution CP 33 specifies the type of the signal C′ and extracts the terminal CID (terminal ID of the terminal 1) from the signal C′ (33-1). Subsequently, the distribution CP 33 refers to the processor table 19 and transfers the signal C′ to the processor 14 according to the number of the processor 14 corresponding to the terminal CID. In this manner, when the terminal related to the control signal does not change even though a control channel changes, a terminating process for the control signal related to the terminal is performed by the control signal processing unit of the same processor.

In formation of the signal C, the following method can be used in place of the process related to (35-1) and (35-2). More specifically, the control signal processing unit generates the signal C in which the terminal CID including the self-processor number is filled to transmit the signal C (FIG. 8: (35-3)). In this manner, the terminal CID included in the signal C′ includes the processor number of the processor which is to terminate the signal C′. For this reason, when the distribution CP extracts the terminal CID as key information, the distribution CP can transfer the signal C′ to the processor having the processor number included in the terminal CID.

A change in mapping of the distribution CP will be described below by using FIGS. 5 and 10. In FIG. 5, when the signaling unit 21 receives a call control signal 1 (terminal 1) related to the control channel (a), the signaling unit 21 transfers the call control signal 1 to the distribution CP 31 of the processor 12 according to the storage contents of the distribution CP table 25a. The distribution CP 31 transfers the call control signal 1 to the control signal processing unit 35 of the processor 14 according to the storage contents of the processor table 19. The control signal processing unit 35 of the processor 14 terminates the call control signal 1 (terminal 1). For example, the control signal processing unit 35 generates a call control signal 1′ (terminal 1) to transmit the call control signal 1′.

Thereafter, it is assumed that a trouble or a congestion occurs in the processor 12 or that a maintaining operation for the processor 12 is performed. In this case, the distribution CP notification unit 36 of the processor 12 performs the process shown in FIG. 10.

More specifically, the distribution CP notification units 36 detects that the distribution CP of the processor 12 cannot be used due to the trouble or the like (S361) At this time, the distribution CP notification units 36 uses the number (number of the self-processor: held in advance) of the processor in which the trouble or the congestion occurs to find a corresponding distribution CP (control channel corresponding to the distribution CP) on the basis of the table 18 (S362). In this example, the control channel (a) (distribution CP 31) is found.

The distribution CP notification units 36 finds a processor which is normal or has a light load (e.g., the lightest load) and acquires the number of the processor (S363). In this case, for example, it is assumed that the processor 15 is found.

The distribution CP notification units 36 sets the processor number found in step S363 at a corresponding position of the table 18 (S364). More specifically, the distribution CP notification units 36 updates the processor number corresponding to the control channel of the control signal received by the distribution CP of the process in which the trouble occurs is replaced with the processor number found in step S363. In this example, since the distribution CP 31 of the processor 12 in which the trouble occurs receives the control signal of the control channel (a), the distribution CP notification units 36 updates the processor number (number of the processor 12) of the control channel (a) in the table 18 with the number of the processors 15.

The distribution CP notification units 36 notifies a related signaling unit of distribution CP information. The distribution CP information indicates the update contents (the contents of a change in mapping of the distribution CP) of the table 18 and includes the changed processor number. In this example, since the processor 12 maps only the distribution CP 31 for performing a distribution process of the control signal of the control channel (a), the related signaling unit is only the signaling unit 21. Therefore, the distribution CP notification units 36 notifies the signaling unit 21 of the number of the processors 15 as distribution CP information.

When the signaling unit 21 receives the distribution CP information (number of the processors 15), as shown in FIG. 10, the signaling unit 21 sets the distribution CP information in the distribution CP table 25a. More specifically, as a transfer destination of the control signal, the processor 12 is replaced with the processor 15.

As described above, the mapping state of the distribution CP is changed. At this time, the processor 15 starts the process of the distribution CP 31. As this start, for example, the following method can be applied.

(1) The processors 12 to 15 always refer to the table 18. When self-processor numbers are written in the table 18, the processors 12 to 15 start the distribution CPs of the control channels corresponding to the processor numbers.

(2) A start instruction of the distribution CP of the control channel is received from the distribution CP notification units 36. In this manner, a state in which the distribution CP 31 (distribution CP for performing a distribution process of the control channel (a)) is arranged in the processor 15 is set.

Thereafter, the signaling unit 21 does not transfer the control signal (e.g., the call control signal 2 (terminal 1) in FIG. 5) to the processor 12, but transfers the control signal to the processor 15. In this case, the distribution CP 31 arranged in the processor 15 transfers a call control signal 2 to the control signal processing unit 35 of the processor 14 which processes the control signal of the terminal 1 on the basis of the key information extracted from the call control signal 2.

When a plurality of distribution CPs are mapped on the processor in which a trouble or the like occurs, at least one alternate processor is found. At this time, the corresponding distribution CPs may be mapped on one processor, or the distribution CPs may be mapped on a plurality of processors. A manner of mapping depends on the state of a load sharing state on the occasion. In this case, a plurality of signaling units are notified of the distribution CP information.

As described above, when the distribution CP notification unit of an arbitrary processor detects that the distribution CP mapped on the processor cannot be used due to a trouble, a congestion, or a maintaining operation, the distribution CP mapped on the processor is mapped on another processor again. In order to detect the trouble, the congestion, and the maintaining operation, a detection method which is conventionally employed can be applied. For example, detection of a warning by a hardware alarm register, detection using an activity ratio of a CPU (processor), detection of a maintaining operation from an operation panel, and the like can be applied. In a change in mapping, in order to prevent a control signal from being partially lost, a trouble of a distribution CP is detected on the signaling unit side, or an arrival check of the control signal is performed, and the control signal may re-transmitted in an abnormal state.

In this manner, the mapping state (setting state) of the distribution CP can be changed. Therefore, depending on a quantity of reception (traffic density) of control signals to the base station control apparatus 100, the mapping state of the distribution CP can be changed, and generation of a bottleneck or partial loss of a signal can be prevented.

[Second Embodiment]

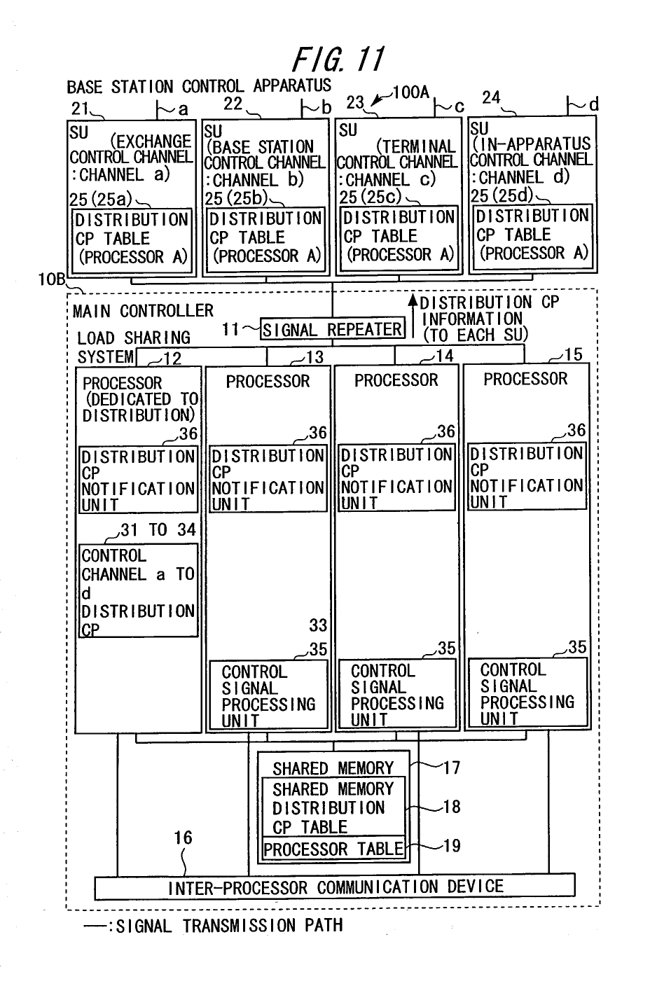

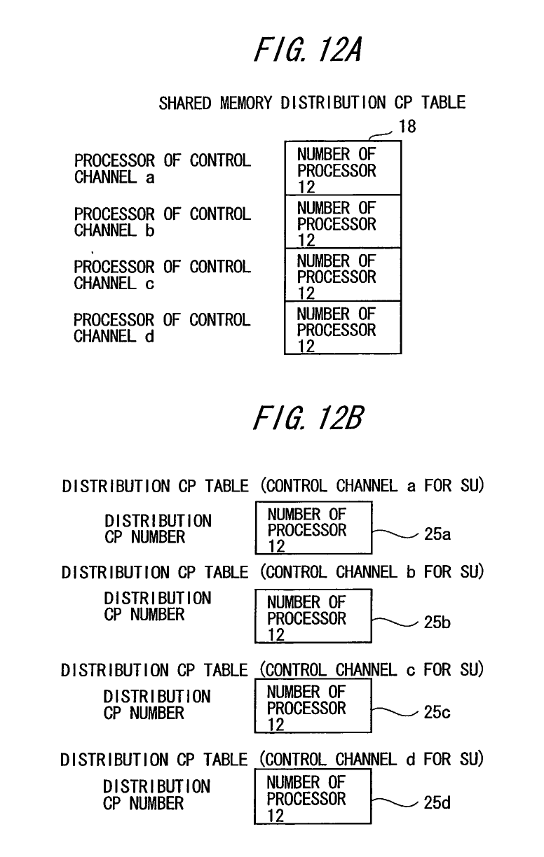

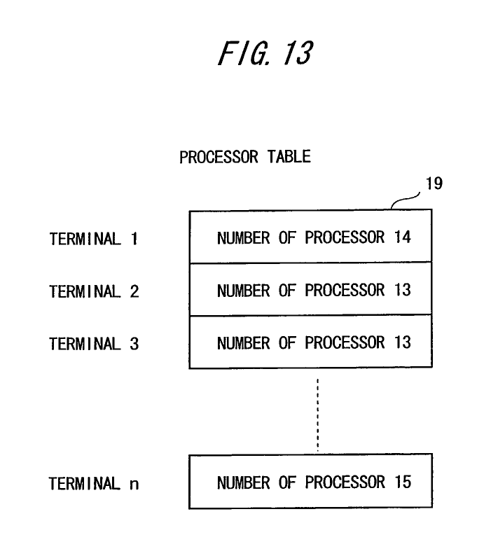

The second embodiment of the present invention will be described below with reference to the accompanying drawings. FIG. 11 is a diagram of a base station control apparatus according to the second embodiment of the present invention. FIG. 12A is a diagram showing a shared memory distribution CP table in the second embodiment, and FIG. 12B is a diagram showing a distribution CP table in the second embodiment. FIG. 13 is a diagram showing a processor table in the second embodiment. Since the second embodiment and the first embodiment have common points, a description of the common points will be omitted, and different points will be mainly described below.

In the second embodiment, an example in which an arbitrary processor is used as a processor dedicated to a distribution process to prevent congestion in a distribution CP from acting as a bottleneck in a processing for a control signal will be described below. No control signal processing unit (processor) is mapped on the processor dedicated to the distribution process.

In the example shown in FIG. 11, the processor 12 serves as a processor dedicated to a distribution process, and distribution CPs 31 to 34 of control channels (a) to (d) are mapped on the processor 12. For this reason, as shown in FIGS. 12A and 12B, all transfer destinations of the control signals of the control channels (a) to (d) are set in the processor 12.

On the other hand, no control signal processing unit 35 is mapped on the processor 12. For this reason, as shown in FIG. 13, as a transfer destination in a processor table 19, the number of the processor 12 is not stored.

In consideration of a trouble, a congestion, a maintaining operation in the processor 12, some or all of the distribution CPs 31 to 34 can be re-mapped on other processors 13 to 15 by the mapping change process described in the first embodiment.

According to the present invention, the base station control apparatus can flexibly cope with a change in system. According to the present invention, the bottleneck of the signal distribution process can be relieved. In addition, a support range of the control signal can be widened.

The configurations described in the first and second embodiments are examples, and the present invention is not limited to the configurations of the embodiments. The constituent elements described in the embodiments can be appropriately changed without departing from the spirit and scope of the invention.

What is claimed is:

1. A signal distribution apparatus for a load sharing multiprocessor comprising:
a plurality of processors; and
at least one distribution portion which is prepared per distribution unit and set at least one of the plurality of processors, each distribution portion receives control signals and distributes each control signal to one of the plurality of processors.

2. A signal distribution apparatus according to claim 1, wherein at least one signal processing portion processing a control signal is set in at least one of the plurality of processors, and the distribution portion distributes each control signal to one of the processors having the signal processing portion.

3. A signal distribution apparatus according to claim 1, wherein the distribution portion is prepared per control channel, and each distribution portion receives control signals related to a corresponding control channel.

4. A signal distribution apparatus according to claim 1, wherein the distribution portion specifies a processor corresponding to a distribution destination on the basis of a piece of key information specified from an information element being included in a control signal.

5. A signal distribution apparatus according to claim 4, wherein the distribution portion extracts an information element depending on the type of the control signal to specify the key information.

6. A signal distribution apparatus according to claim 4, wherein the distribution portion distributes a plurality of control signals in which load balancing units specified by the key information are equal to each other to the same processor in the order of reception of the plurality of control signals.

7. A signal distribution apparatus according to claim 1, further comprising changing means for dynamically changing a setting state of at least one distribution portion for the plurality of processors.

8. A signal distribution apparatus according to claim 7, wherein the changing means changes a setting state of the distribution portion depending on a quantity of control signal.
